(19) United States
(12) Patent Application Publication
(10) Pub. No.: US 2012/0132585 A1
(43) Pub. Date: May 31, 2012

(54) Slant Plates for Flocculation Formation and Flocculation Settling Treatment Tank Adopting the Slant Plates for Flocculation Formation

(75) Inventors: Hisaaki Ochiai, Tokyo (JP); Hiroshi Kyotani, Osaka (JP)

(73) Assignee: Hisaaki Ochiai, Tokyo (JP)

(21) Appl. No.: 13/304,950

(22) Filed: Nov. 28, 2011

(30) Foreign Application Priority Data
Nov. 29, 2010 (JP) 2010-264657

(51) Int. Cl. C02F 1/52

(52) U.S. Cl. 210/513

(57) ABSTRACT

Slant plates for flocculation formation that efficiently form turbulent flow or vortical flows are installed in a settling treatment tank that performs a flocculation step including a step of further flocculating microfloc particles formed by an inorganic flocculant injection step and a micro flocculation step of micro-flocculating fine suspended particles by mixing and agitating in a rapid agitation tank; and a settling and separation treatment step for the floc particles; and an opening including an upper side edge and a lower side edge along a direction orthogonal to a direction of a slant surface is formed in each slant surface and a flocculation settling treatment tank in which the slant plates for flocculation formation are arranged at an uppermost portion or at a middle part.

### FIELD OF THE INVENTION

This invention relates to slant plates for flocculation formation that relates to flocculation as well as settling and separation treatment in a settling treatment tank that performs the following steps: a flocculation step comprising a step of further flocculating, by contact with existing floc particles, microfloc particles formed by an inorganic flocculant injection step of injecting an inorganic flocculant into water to be treated and a micro flocculation step of micro-flocculating in advance fine suspended particles in the water to be treated by mixing and agitating the water to be treated into which the inorganic flocculant has been injected in a rapid agitation tank; and a settling and separation treatment step for the floc particles.

### BACKGROUND OF THE INVENTION

Flocculation settling treatment of water to be treated has been adopted as a prior treatment of sand filtration. In this flocculation settling method, inorganic flocculant is injected into water to be treated to agglomerate fine suspended particles contained in the water to be treated into flocs having a diameter that can be settled and separated, and thus settling and separation treatment of the flocs is performed by the action of gravity.

When performing flocculation settling treatment of water to be treated, slant plates for flocculation formation are arranged at a final stage of flocculation or at a middle part up to the final stage, and are caused to contribute to flocculation formation of microflocs.

With respect to the slant plates for flocculation formation, respective slant plates are formed by arranging a plurality of flat plates side by side in a parallel state, and flocculation is realized based on collisions between microflocs caused by generating turbulent flow and/or vortical flows between the respective slant plates, especially at a lower end face of the slant plates and an upper side thereof.

However, in the case of these kinds of plates that have a flat shape, a limit exists with respect to formation of turbulent flow and/or vortical flows.

In view of the above described situation, in Patent Literature 1, a configuration is proposed in which fin-ray plates are arranged with appropriate distances therebetween at positions that are further on an upper side than a bottom face of a slant plate for flocculation formation. According to the configuration proposed in Patent Literature 1, the extent to which turbulent flow and/or vortical flows are formed is increased by collision between the fin-ray plates and water to be treated, and the configuration also complements the settling of particles.

According to the above described configuration, turbulent flow and/or vortical flows can certainly be formed in the vicinity of each fin-ray plate and the frequency of collisions between microflocs can be increased.

However, the above described configuration includes a critical drawback in the respect that flocs that are formed by collisions between microflocs accumulate at regions on the upper side of the respective slant plates that are at the bases of the fin-ray plates, and the flocs cannot drop down from the respective slant plates.

Thus, according to the conventional technique, a configuration has not been proposed that forms turbulent flow and/or vortical flows that increase the frequency of collisions between microflocs more than in the case of using flat plates, and also makes it possible for microflocs to drop down from the slant plates.

### PRIOR ART

### Patent Literature

[Patent literature 1] Publication of Unexamined Patent Application No. Sho 48-018855

### Problems to be Solved by the Invention

An object of this invention is to provide slant plates for flocculation formation that, in comparison to a case of a flat plate, make it possible to realize turbulent flow and/or vortical flows that increase the frequency of collisions between microflocs, and also make it possible for flocs formed by collisions between microflocs to drop down along each slant surface, as well as a configuration of a flocculation settling treatment tank that adopts the slant plates for flocculation formation.

### Solutions to Problems

To solve the above described problem, a basic configuration of this invention comprises:

(1) slant plates for flocculation formation that relates to flocculation as well as settling and separation treatment in a settling treatment tank. A flocculation step comprises a step of further flocculating, by contact with existing floc particles, microfloc particles formed by an inorganic flocculant injection step of injecting an inorganic flocculant into water to be treated and a micro flocculation step of micro-flocculating in advance fine suspended particles in said water to be treated by mixing and agitating said water to be treated into which said inorganic flocculant is injected in a rapid agitation tank. The flocculation step and a settling and separation treatment step for the floc particles is performed in the settling treatment tank. An opening including an upper side edge and a lower side edge along a direction orthogonal to a direction of a slant surface is provided in the respective slant plates; and
(2) a flocculation settling treatment tank wherein the slant plates for flocculation formation according to the above (1) are arranged at an uppermost portion or at a middle part up to the uppermost portion.

### ADVANTAGES OF THE INVENTION

According to this invention based on the above described basic configuration, by generating turbulent flow and/or vortical flows at an upper side edge of an opening and an upper side thereof in a similar manner to when generating turbulent flow and/or vortical flows at a lower side end of respective slant plates, on the one hand the frequency of collisions between microflocs is enhanced and, consequently, efficient flocculation and flocculation settling treatment is promoted, and on the other hand, because the efficiency is improved in this manner, the capacity of the flocculation settling treatment tank can be reduced.

### BRIEF DESCRIPTION OF THE DRAWINGS

FIGS. 1(a) to (c) are plan views of slant plates for flocculation formation that illustrate a basic configuration of this invention, in which (a) illustrates rectangular openings, (b) illustrates triangular openings, and (c) illustrates semicircular openings;

FIGS. 2(a) and (b) are sectional side views relating to height positions of openings, in which (a) illustrates an example of an embodiment in which height positions of openings in each slant plate are set uniformly, and (b) illustrates an example of an embodiment in which, with respect to a pair of adjacent slant plates for flocculation formation, height positions at which openings of one of the slant plates for flocculation formation are formed and height positions at which slant surfaces of the other slant plate for flocculation formation are formed correspond with each other and are set uniformly;

FIGS. 3(a) and (b) are plan views of an example of embodiment in which protrusions that contact a slant surface of each adjacently positioned slant plate along a slant direction are provided from an upper end of a slant plate for flocculation formation or the vicinity of the upper end to a lower end or the vicinity thereof, in which (a) illustrates a case in which the protrusions are a linear shape, and (b) illustrates a case in which the protrusions are a snaking shape;

FIGS. 4(a) to (c) are views that illustrate the configuration of an example of embodiment in which, in respective slant plates, at a region in which an opening does not exist and a region that straddles an opening, a plurality of projection-shaped recessed portions that contact a slant surface of each adjacently positioned slant plate are provided in a direction orthogonal to the slant surface direction, and a plurality of columns of the projection-shaped recessed portions are provided along the slant surface direction, in which (a) shows a plan view, (b) shows a sectional view in a direction orthogonal to the slant direction, and (c) shows a sectional view in the slant direction; and

FIG. 5 is a graph that illustrates a situation in which, with respect to cases in which a number of columns of openings along a slant plate direction is made 0, 1, 2, and 3, respectively, when providing slant plates for flocculation formation in a settling treatment tank, a reduction rate changes with respect to a state in which slant plates for flocculation formation of particles of respective diameter ranges are not provided.

### DESCRIPTIONS OF THE INVENTION

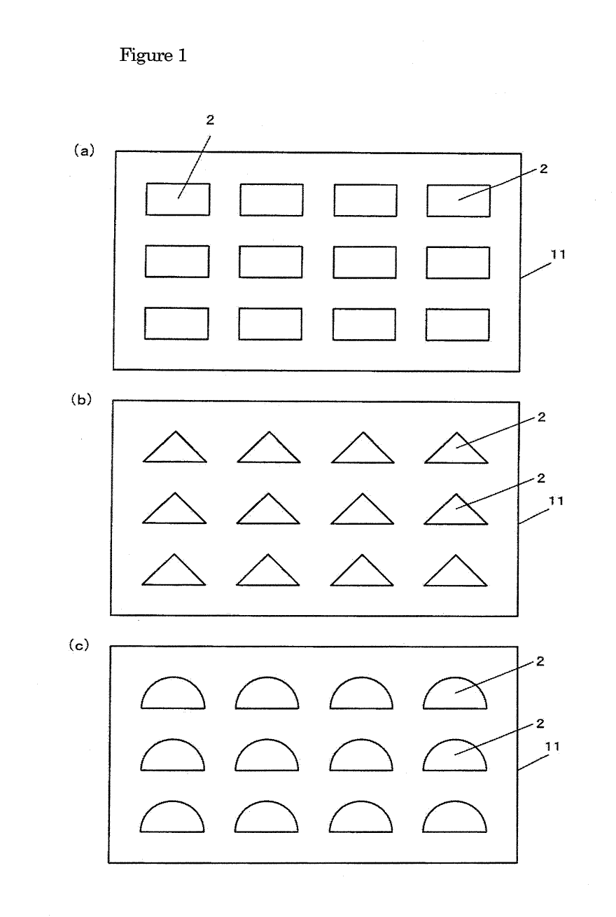

As shown in the plan views of FIG. 1, as a basic configuration, this invention adopts a configuration in which one or more openings 2 that include an upper side edge and a lower side edge along a direction orthogonal to a slant surface are arranged in a single column or a plurality of columns along the slant surface.

With respect to the number of openings 2 in a direction orthogonal to the slant surface, both a configuration in which a single opening 2 is provided along the relevant direction and a configuration in which a plurality of openings 2 are provided along the relevant direction can be adopted, and the number of openings 2 will depend on the width of each slant plate 11 and the width of the opening 2 in the relevant direction.

In both of the aforementioned configurations, in a case where water to be treated collides with the upper side edge, similarly to a case where water to be treated flows at the lower end portion of each slant plate 11 and the upper side thereof, localized turbulent flow and/or localized vortical flows arise when the water to be treated flows at the upper side end portion of the upper side edge as well as an upper side thereof. In regions in which the turbulent flow and/or vortical flows arise, collisions between microflocs frequently occur and flocculation is promoted.

With regard to the shape of the opening 2, although there are many cases in which the opening 2 is a rectangular shape as shown in FIG. 1(a), the shape of the opening 2 is not limited to a rectangular shape. Naturally, a triangular shape as shown in FIG. 1(b) or a semicircular shape as shown in FIG. 1(c) can also be adopted, and shapes other than these can also be adopted.

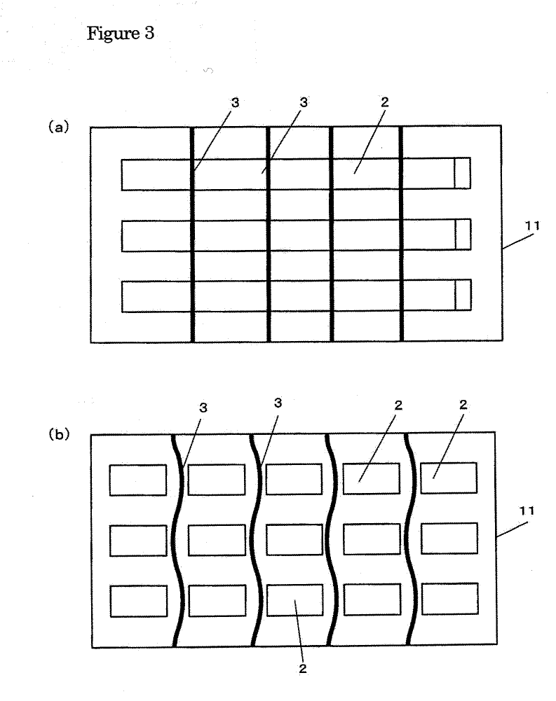

When the opening 2 has a rectangular shape as shown in FIG. 1(a), for example, as shown in FIG. 3(a), it is possible to form a single opening 2 that has a rectangular shape in a direction orthogonal to the slant direction, and realize the turbulent flow and/or vortical flows over a wide range in the direction orthogonal to the slant direction.

On the other hand, when the opening 2 has the aforementioned triangular shape or semicircular shape, there are normally many cases in which a plurality of the openings 2 are provided in line with the orthogonal direction, and since the length of the upper side edge at which turbulent flow and/or vortical flows arise is longer compared to the case of a rectangular shape per opening 2, this can also contribute to efficient formation of turbulent flow and/or vortical flows.

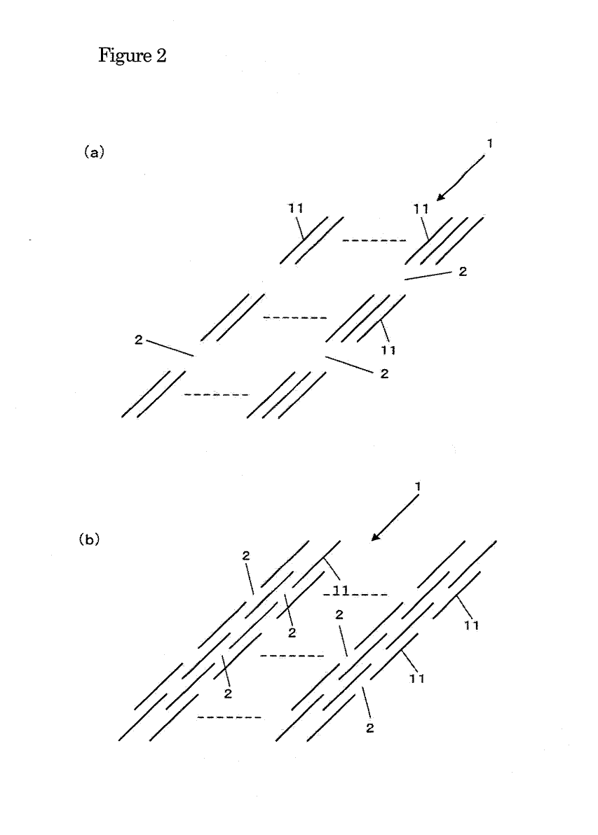

The openings 2 are formed in each slant plate 11. As shown in FIG. 2(a), as the arrangement state of respective slant plates 11, an example of an embodiment in which height positions of the openings 2 in each slant plate 11 are set uniformly is adopted as a typical example. However, as shown in FIG. 2(b), an example of an embodiment can also be adopted in which, with respect to a pair of adjacent slant plates for flocculation formation 1, height positions at which the openings 2 of one of the slant plates for flocculation formation 1 are formed and height positions at which slant surfaces of the other of the slant plates for flocculation formation 1 are formed correspond to each other and are set uniformly.

However, various forms can be adopted with respect to the arrangement state of the openings 2 for each slant plate 11, and this invention is not limited to the examples illustrated in FIG. 2(a) and FIG. 2(b).

In the case illustrated in FIG. 2(a), with regard to the mutual relationship between each slant plate 11, a state arises in which a slant surface that is based on a predetermined pitch is not formed at a region in the height direction in which the openings 2 are formed. Therefore, in order to adjust for this kind of state, use of the aforementioned pitch is suited to narrow slant plates for flocculation formation 1.

In contrast, in the case illustrated in FIG. 2(b), a double pitch is formed by adjacently positioned slant surfaces on both sides of a region in a height direction in which the openings 2 are formed. In this case, since there is no region in the height direction in which slant surfaces do not exist as in the example of embodiment illustrated in FIG. 2(a), this arrangement can be suitably used in a case in which the pitch is wider than the case illustrated in FIG. 2(a).

In order to set a predetermined pitch, according to this invention, an example of an embodiment can be adopted in which a plurality of protrusions 3 that contact a slant surface of each adjacently positioned slant plate 11 are provided along the slant surface in a direction orthogonal to the slant surface from an upper end or the vicinity thereof to the lower end or the vicinity thereof of each slant plate 11.

The pitch is defined by the degree of projection of the protrusions 3. Furthermore, the strength of the slant plates for flocculation formation 1 can be reinforced in the respect that the respective slant plates 11 do not curve along the slant surface direction.

The protrusions 3 that have a linear shape shown in FIG. 3(a) are suited to a simple and rapid manufacturing process.

On the other hand, the protrusions 3 that have a snaking shape shown in FIG. 3(b) can contribute to formation of turbulent flow and/or vortical flows as a result of water to be treated colliding with the protrusions 3.

Efficient flocculation and flocculation settling treatment can be promoted in a settling treatment tank that adopts the slant plates for flocculation formation 1 based on the invention of the present application. In particular, as described in the description of Japanese Patent No. 4316671, when the pitch is set to be 5 mm or more and 50 mm or less and the amount of inorganic flocculant in the inorganic flocculant injection step is limited so that an amount of turbidity of the water to be treated after passage through the slant plates for flocculation formation 1 is ⅘ of an amount of turbidity of the water to be treated prior to passage through the slant plates for flocculation formation 1, the number of microflocs can be reduced and the density of floc particles can be set to a high density. Hence, excellent flocculation settling treatment can be realized by combining this effect with the effect of the slant plates for flocculation formation 1 of the invention of the present application.

An example of an embodiment of this invention is described hereunder.

### Example of Embodiment

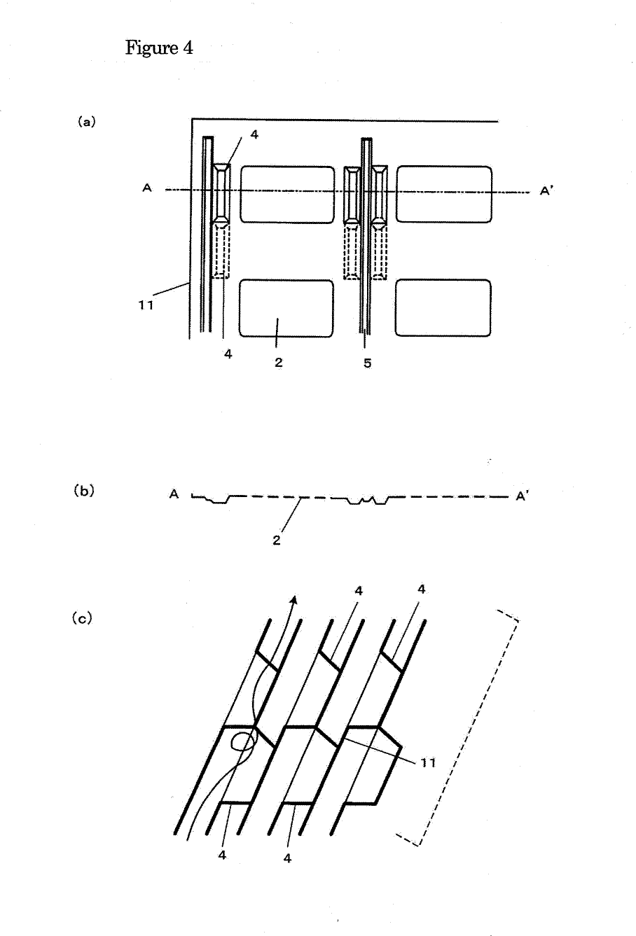

A feature of the present example of embodiment is that, as shown in FIGS. 4(a), (b), and (c), in each slant plate 11, a plurality of projection-shaped recessed portions 4 that contact the slant surface of each adjacently positioned slant plate 11 are provided in a direction orthogonal to the slant surface direction in a region in which the opening 2 does not exist or in a region that straddles the opening 2, and a plurality of columns of the projection-shaped recessed portions 4 are provided along the slant surface direction.

According to the example of embodiment, the projection-shaped recessed portions 4 do not merely define the pitch. Rather, in projecting parts that are formed accompanying formation of the recessed portions, an outer wall on a lower side collides with water to be treated that rises along the slant surface, and therefore turbulent flow and/or vortical flows can be formed separately from the turbulent flow and/or vortical flows formed by the opening 2.

In addition, similarly to the case of the aforementioned protrusion 3, the strength of each slant surface can be reinforced.

In this connection, in FIG. 4(a) and (b), although reinforcement protrusions 5 that are provided along the slant surface direction between the projection-shaped recessed portions 4 on both sides do not contact the slant surface of each adjacently positioned slant plate 11 as in the case of the protrusions 3 shown in FIG. 3, the purpose of the reinforcement protrusions 5 is to secure the bending strength in the slant surface direction, and in this respect the reinforcement protrusions 5 perform a similar function as the protrusions 3.

In each example of the embodiment shown in FIG. 4, a form is adopted in which the position of the lower end of the bottom face of the projection-shaped recessed portion 4 matches the position of the upper side edge that serves as a boundary with the slant surface at the projection-shaped recessed portion 4 of the adjacently positioned slant plate 11. With this kind of design, water to be treated that collides with a lower side wall portion of a projecting face that projects downward of the projection-shaped recessed portion 4 of each slant plate 11 can also collide with an upper side inner wall of a projecting face that projects downward of the projection-shaped recessed portion 4 formed in an adjacently positioned slant surface, and can contribute to forming additional turbulent flow and/or vortical flows.

In FIGS. 4(a), (b) and (c), the projection-shaped recessed portions 4 are provided in regions in which the openings 2 are not formed. Naturally, an example of an embodiment in which the projection-shaped recessed portions 4 are provided in regions that straddle the openings 2 along the slant surface direction is also possible. In such a case also, turbulent flow and/or vortical flows can be formed in an intricate manner.

For each slant plate 11 of the example of the embodiment, a width in the slant surface direction was set as 0.8 m and a width in a direction orthogonal thereto was set as 1.46 m. Thereafter, slant plates for flocculation formation 1 in which 23 of the slant plates 11 were arranged at a pitch of 10 mm were prepared for a case in which openings 2 having a rectangular shape with a width in the slant surface direction of 4 cm and a width in an orthogonal direction thereto of 8.6 cm were not formed in the slant plates 11, a case in which one row of the aforementioned openings 2 was arranged at a center portion in the height direction along the slant surface direction, a case in which two rows of the aforementioned openings 2 were evenly arranged in the same manner, and a case in which three rows of the aforementioned openings 2 were evenly arranged in the same manner, respectively.

In the inorganic flocculant injection step, injection is carried out under conditions of 20 mg/L of kaolin and a PAC injection rate of 18.9 mg/L. With respect to the micro flocculation step, upon adopting a rapid agitation tank for three compartments, a numerical value represented by a GR value as the agitation intensity in each rapid agitation tank, that is, a value expressed by the following equation [Equation 1]

$${G}_{R} = \sqrt{\frac{( C \cdot A \cdot {v}^{3} )}{2 \cdot γ \cdot V}}$$

where an agitation coefficient is given as C, an area of an agitation blade is given as A (m²), a peripheral speed of the agitation blade is given as v (m/sec), a coefficient of kinematic viscosity is given as γ (m²/sec) and a volume (capacity) of the agitation tank is given as V (m³), was set to be 150 sec⁻¹, and a surface loading rate was set to be 52.0 mm/min, and a flocculation step was realized by allowing microfloc particles to flow into a flocculation settling treatment tank of a cubic shape of 5 m×5 m×5 m based on the agitation intensity.

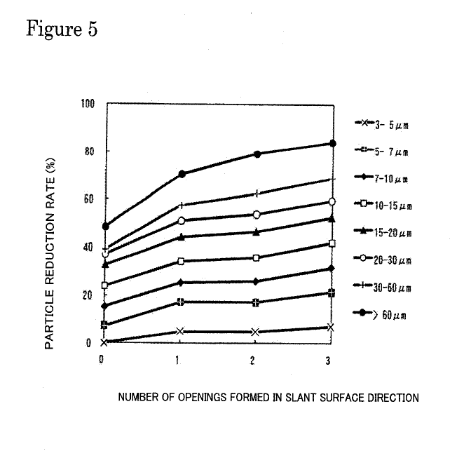

FIG. 5 illustrates a graph showing, with respect to the aforementioned flocculation settling treatment tank, the degree of increase in the reduction rate of particles in respective diameter ranges in the above described cases in which slant plates for flocculation formation 1 in which no openings 2 were formed, one row of the openings 2 was formed, two rows of the openings 2 were formed, and three rows of the openings 2 were formed, respectively, when slant plates for flocculation formation 1 were arranged at an uppermost portion of the flocculation settling treatment tank, in comparison to a case in which the slant plates for flocculation formation 1 were not arranged. More specifically, the graph in FIG. 5 illustrates the degree of increase in the reduction rate of particles in respective region ranges on an inlet side and an outlet side of the flocculation settling treatment tank in the above described cases.

As will be understood from the graph, it was found that the reduction rate of particles in the respective region ranges increased in accordance with an increase in the number of openings 2 arranged along the slant surface direction, and in particular, that the reduction rate increased in accordance with an increase in the particle size.

### INDUSTRIAL APPLICABILITY

This invention can be utilized in all fields in sewage and sludge treatment industries that use inorganic flocculants.

### EXPLANATION OF SYMBOL

1 Slant plates for flocculation formation
11 Respective slant plates
2 Opening
3 Protrusion
4 Projection-shaped recessed portion
5 Reinforcement protrusion

What is claimed is:

1. Slant plates for flocculation formation that relates to flocculation as well as settling and separation treatment in a settling treatment tank, wherein
a flocculation step comprises a step of further flocculating, by contact with existing floc particles, microfloc particles formed by an inorganic flocculant injection step of injecting an inorganic flocculant into water to be treated and a micro flocculation step of micro-flocculating in advance fine suspended particles in said water to be treated by mixing and agitating said water to be treated into which said inorganic flocculant is injected in a rapid agitation tank;
the flocculation step and a settling and separation treatment step for the floc particles is performed in the settling treatment tank; and
said slant plates comprising at least one opening including an upper side edge and a lower side edge along a direction orthogonal to a direction of a slant surface.

2. The slant plates for flocculation formation according to claim 1, wherein height positions of openings in the respective slant plates are set uniformly.

3. The slant plates for flocculation formation according to claim 1, wherein, with respect to a pair of adjacent slant plates for flocculation formation, a height position at which an opening of one of the slant plates for flocculation formation is formed and a height position at which a slant surface of another of the slant plates for flocculation formation is formed correspond to each other and are set uniformly.

4. The slant plates for flocculation formation according to claim 1, wherein each opening includes a shape selected from the group consisting of a rectangular shape, a triangular shape, and a semicircular shape.

5. The slant plates for flocculation formation according to claim 1, wherein, in the respective slant plates at least one of a region in which an opening does not exist and a region that straddles an opening, a plurality of projection-shaped recessed portions that contact a slant surface of each adjacently positioned slant plate are provided in a direction orthogonal to a slant surface direction and are provided in a plurality of columns along the slant surface direction.

6. The slant plates for flocculation formation according to claim 5, wherein a position of a lower end of a bottom face of the projection-shaped recessed portion matches a position of an upper side edge that corresponds to a boundary with the slant surface at a projection-shaped recessed portion of each adjacently positioned slant plate.

7. The slant plates for flocculation formation according to claim 1, wherein a plurality of protrusions that contact a slant surface of each adjacently positioned slant plate are provided along a slant surface along a direction orthogonal to the slant surface from an upper end or a vicinity thereof to a lower end or a vicinity thereof of each of the slant plates.

8. The slant plates for flocculation formation according to claim 7, wherein each protrusion is selected from the group consisting of a linear shape and a snaking shape.

9. A flocculation settling treatment tank in which slant plates for flocculation formation according to claim 1 are arranged at least one of:
an uppermost portion thereof and
at a middle part up to the uppermost portion.

10. The flocculation settling treatment tank according to claim 9, wherein a pitch is set to be 5 mm or more and 50 mm or less, and an amount of the inorganic flocculant in the inorganic flocculant injection step is limited so that an amount of turbidity of water to be treated after passage through the slant plates for flocculation formation is ⅘ of an amount of turbidity of the water to be treated before passage through the slant plates for flocculation formation.
